(19) United States
(12) Patent Application Publication
(10) Pub. No.: US 2015/0283951 A1
(43) Pub. Date: Oct. 8, 2015

(54) Carrying System for Jeep Doors and Hardtop

(71) Applicant: Chris Singleton, Rogersville, TN (US)

(72) Inventor: Chris Singleton, Rogersville, TN (US)

(21) Appl. No.: 14/679,553

(22) Filed: Apr. 6, 2015

Related U.S. Application Data
(60) Provisional application No. 61/975,419, filed on Apr. 4, 2014.

(51) Int. Cl. B60R 9/06

(52) U.S. Cl. CPC B60R 9/06

(57) ABSTRACT

A carrying system for a jeep hardtop, which includes a carrier that allows the hardtop and doors to be detached from the vehicle but still kept with the vehicle while removed. The carrying system allows for easy attachment and securing of the hardtop and doors to the carrier. In some example embodiments, the carrier attaches to the hitch and to the rear-mounted spare tire carrier of the jeep. In other example embodiments, the carrier attaches to the vehicle only at the hitch. Conveying the doors and hardtop with the jeep allows the jeep, at any time and in any place, to be converted quickly between convertible and non-convertible modes, depending on weather conditions and other factors.

### CROSS-REFERENCE TO RELATED APPLICATIONS

This Application claims the benefit of U.S. Provisional Patent Application Ser. No. 61/975,419, filed Apr. 4, 2014, the entirety of which is incorporated herein by reference.

### STATEMENT REGARDING FEDERALLY SPONSORED RESEARCH OR DEVELOPMENT

Not Applicable

### BACKGROUND OF THE INVENTION

1. Field of Invention

This invention pertains generally to portable carrying and storage systems for removable vehicle doors and hardtops and, more particularly, to carrying systems for jeep hardtops and doors.

2. Description of the Related Art

Often, the drivers of certain types of Sport Utility Vehicles (SUV) desire to ride in an open vehicle or to maximize the usable interior space of the vehicle. Often, this mode of operation requires removing of the doors and hardtop of the particular vehicle.

In the past, removed doors often were carried in the rear seat or secured by elastic cords to the rear spare tire of the vehicle. In the former instance, the concept of maximizing interior space is negated. The latter option can cause damage to the plastic door windows or warpage of the doors due to the uneven surface of the spare tire. Doors could be sometimes left behind, but this presented a problem if the doors were needed later to protect against severe weather conditions. A system for efficiently and safely mounting and transporting removable SUV doors on the rear of the vehicle would certainly be a welcome addition to the art.

U.S. Pat. No. 7,293,681, issued to Willis, discloses a rack designed to provide convenient storage of doors optionally removable from a jeep-style Sport Utility Vehicles. This allows a driver to operate the vehicle with the doors removed and thus free up interior space. The rack is mounted on the rear of the vehicle exteriorly of the rear-mounted spare tire. Mounted securely in the rack, the doors are spaced from the spare tire and are prevented from rubbing each other and the spare tire. The doors are therefore protected from scratches and abrasions.

Willis does not disclose removal or storage of the jeep hardtop.

BRIEF SUMMARY OF THE INVENTION

A carrying system for a jeep hardtop, which includes a carrier that allows the hardtop and doors to be detached from the vehicle but still kept with the vehicle while removed, is disclosed herein. The carrying system allows for easy attachment and securing of the hardtop and doors to the carrier. In some example embodiments, the carrier attaches to the hitch and to the rear-mounted spare tire carrier of the jeep. Carrying the doors and hardtop with the jeep allows the jeep, at any time and in any place, to be converted quickly between convertible and non-convertible modes, depending on weather conditions and other factors.

In some embodiments of the present general inventive concept, a carrying system for a jeep hardtop and doors includes a carrier with a frame, said frame supporting a plurality of braces and brackets to receive and support the hardtop and doors of the jeep, a mounting member to attach said frame to a hitch on the jeep, and an assembly to attach said frame to a rear-mounted spare tire carrier of the jeep.

In some embodiments, the assembly to attach said frame to a rear-mounted spare tire carrier of the jeep includes bolts to fasten the frame to the rear-mounted spare tire carrier of the jeep.

In some embodiments, the frame includes a stabilizer brace.

In some embodiments, the frame includes safety chains.

In some embodiments, the frame includes padding. In some embodiments, some of said braces and brackets include padding.

### BRIEF DESCRIPTION OF THE DRAWINGS

The above-mentioned and additional features of the invention will become more clearly understood from the following detailed description of the invention read together with the drawings in which:

FIG. 1 is a side view of one example embodiment of a carrying system for a jeep hardtop, showing the carrier before attachment to the back of the jeep and with the jeep hardtop still in place on the jeep;

FIG. 2 is a second side view of the example embodiment shown in FIG. 1, showing the carrier attached to the back of the jeep;

FIG. 3 is a third side view of the example embodiment shown in FIG. 1, showing the doors of the jeep detached from the jeep and positioned on the carrier;

FIG. 4 is a fourth side view of the example embodiment shown in FIG. 1, showing the doors and the hardtop positioned on the carrier;

FIG. 5 is a view of the example embodiment shown in FIGS. 1-4, looking head-on at the carrier and the back of the vehicle;

FIG. 6 is a side view of another example embodiment of a carrying system for a jeep hardtop, showing an illustrative example embodiment of a carrier adapted to hold two doors; and

FIG. 7 is a top-down view of the example embodiment shown in FIG. 6.

### DETAILED DESCRIPTION OF THE INVENTION

Disclosed herein is a carrying system for a jeep hardtop, which includes a carrier that allows the hardtop and doors to be detached from the vehicle but still kept with the vehicle while removed. The carrying system allows for easy attachment and securing of the hardtop and doors to the carrier. In some example embodiments, the carrier attaches to the hitch and to the rear-mounted spare tire carrier of the jeep. In other example embodiments, the carrier attaches to the vehicle only at the hitch. Conveying the doors and hardtop with the jeep allows the jeep, at any time and in any place, to be converted quickly between convertible and non-convertible modes, depending on weather conditions and other factors.

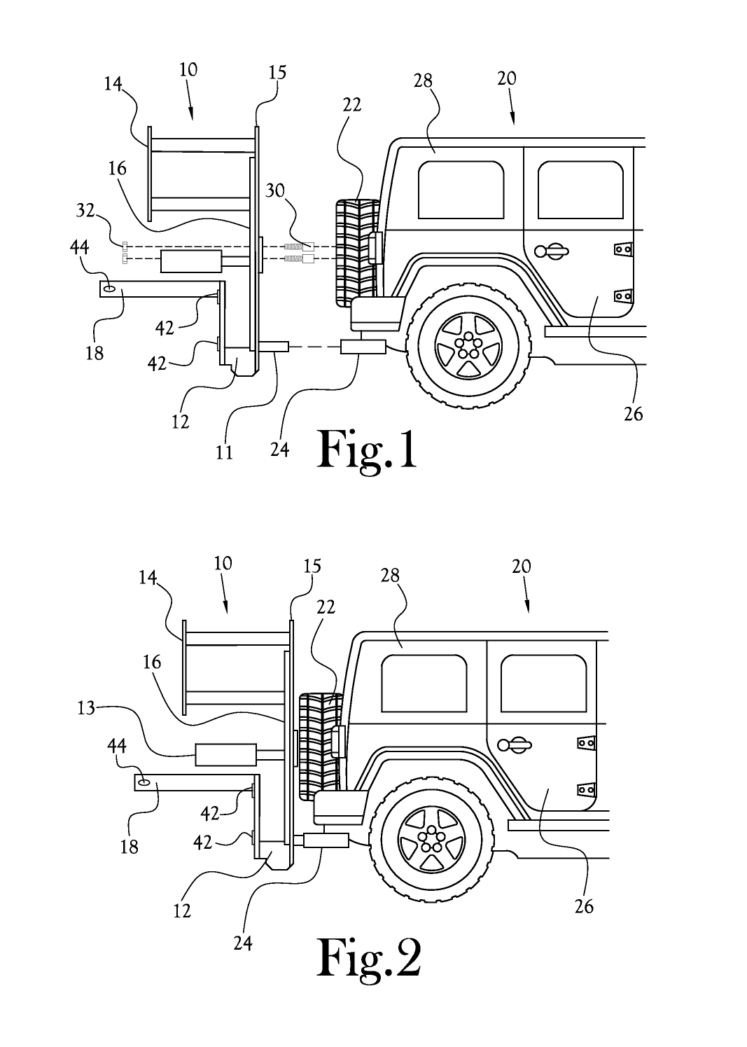

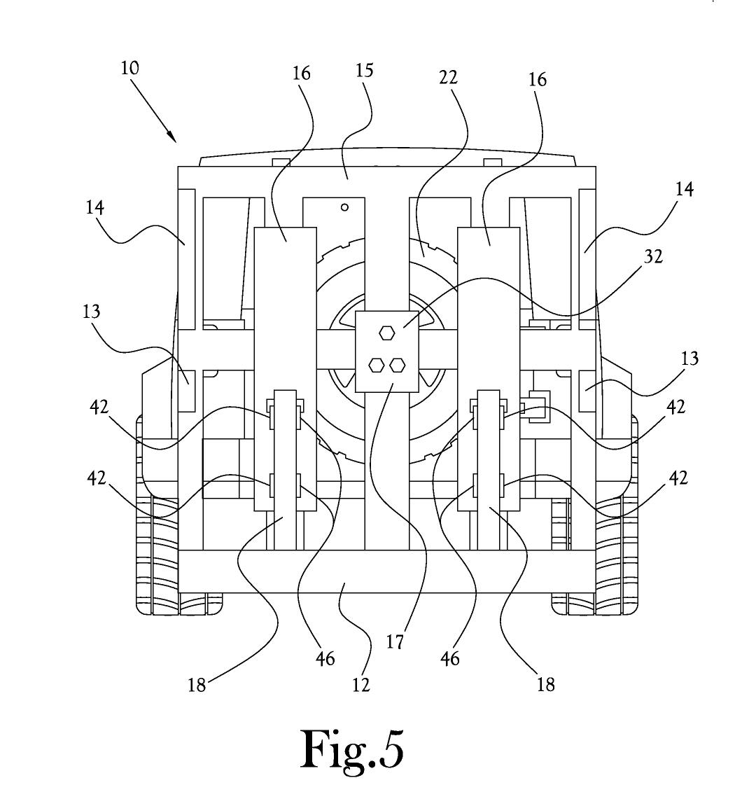

Turning to the figures, FIG. 1 illustrates one example embodiment of a carrying system for a jeep hardtop. In the illustrated example embodiment, the carrier 10 includes a mounting member 11 to attach the carrier 10 to the hitch 24 of a jeep 20 or other vehicle. The carrier 10 also includes a main frame 15, to which are attached other components that extend away from the vehicle 20. These other components of the carrier 10, attached to and extending from the main frame 15, include hardtop brackets 13 to hold the hardtop, wind guards 14 to protect the hardtop, and door mounting brackets 18 joined to the frame by a lower front edge support bracket 12. Generally, the door mounting brackets 18 include hinge loops 42 to receive the hinges of the doors, and hooks or loops 44 that receive and engage the latches of the vehicle doors; these components help secure the door to the carrier 10. As shown in FIG. 5, some embodiments of the present general inventive concept include additional sets of hinge loops 46 and other components to receive up to four doors on the carrier 10, for use with four-door vehicles.

Also shown in the view in FIG. 5, in some example embodiments the main frame 15 also includes padded rails 16 or other padding to protect the hardtop from jostling or bumping into the frame. In various embodiments, other components of the carrier are similarly padded, for similar purposes. For instance, in some embodiments, the lower front edge support bracket 12 is padded because part of the hardtop rests on the lower front edge support bracket 12.

As shown in FIG. 1 and FIG. 5, the carrier 10 attaches to the jeep 20 at two points: first, where the mounting member 11 fits onto the hitch 24, and second, through a series of mounting adapters 30, the long shafts of which pass through a mounting plate 17 on the carrier main frame 15 and attach to the existing bolts coming through the spare tire 22 to connect with the spare tire carrier. The mounting adapters 30 and their nuts 32 secure the main frame 15 to the existing spare tire carrier apparatus.

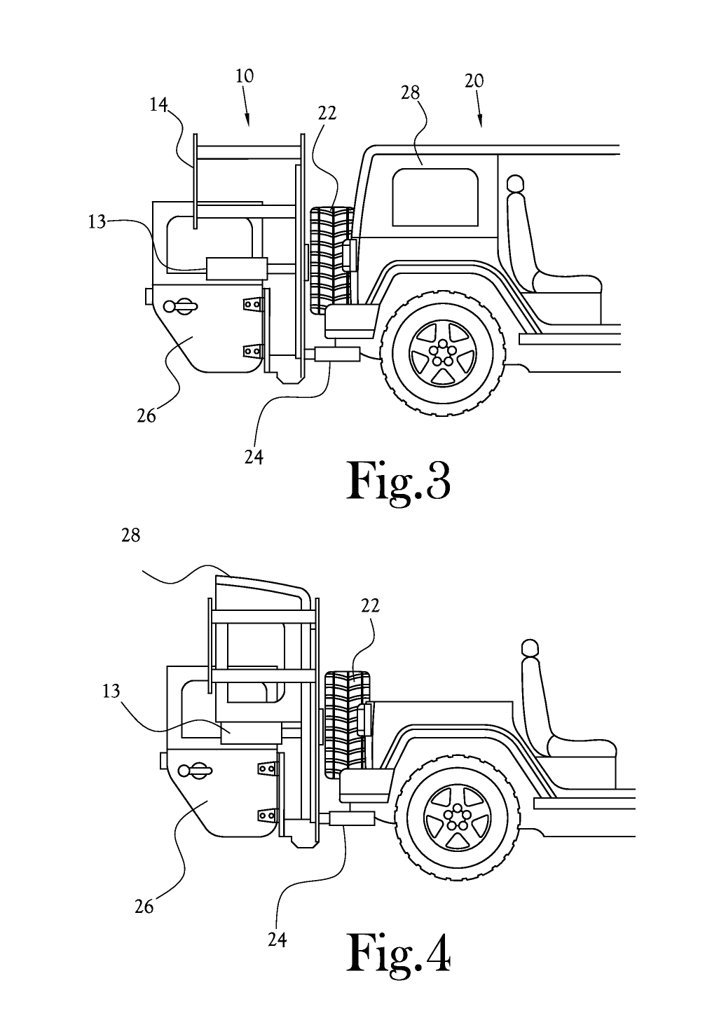

FIG. 2 shows the carrier 10 attached to the back of the jeep 20, and FIGS. 3 and 4 illustrate how the doors and hardtop of the jeep 20 are loaded onto the carrier 10. As shown in FIG. 3, a side door 26 of the jeep 20 is detached from the jeep 20 and loaded onto the carrier 10 between one of the door mounting brackets 18. After all doors (generally two or four) are detached and loaded in this manner, the hardtop 28 is also detached from the jeep 20 and loaded onto the hardtop brackets 13 in the upper portion of the carrier 10, as shown in FIG. 4.

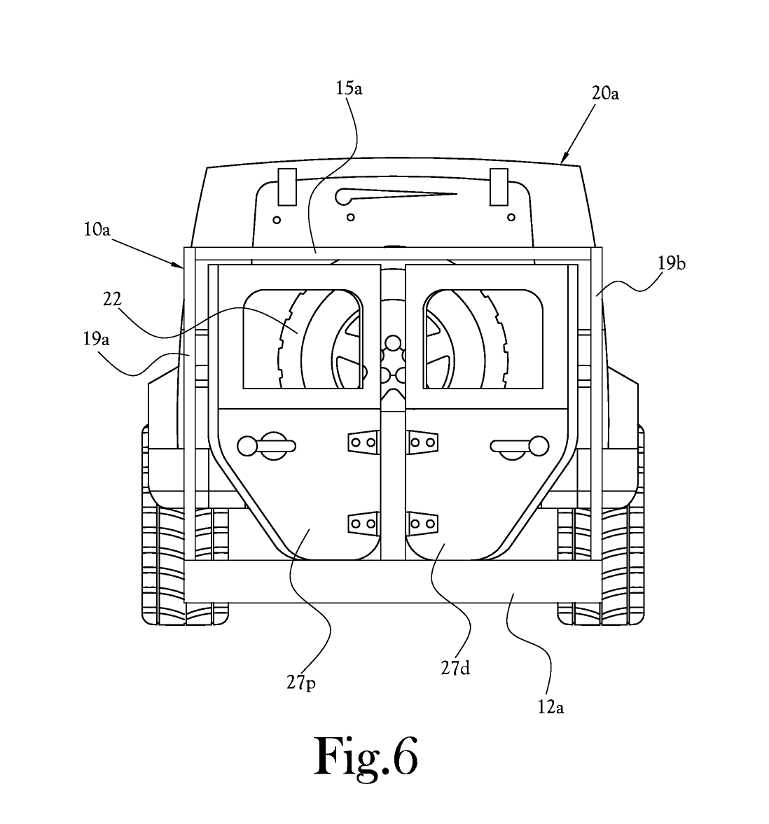

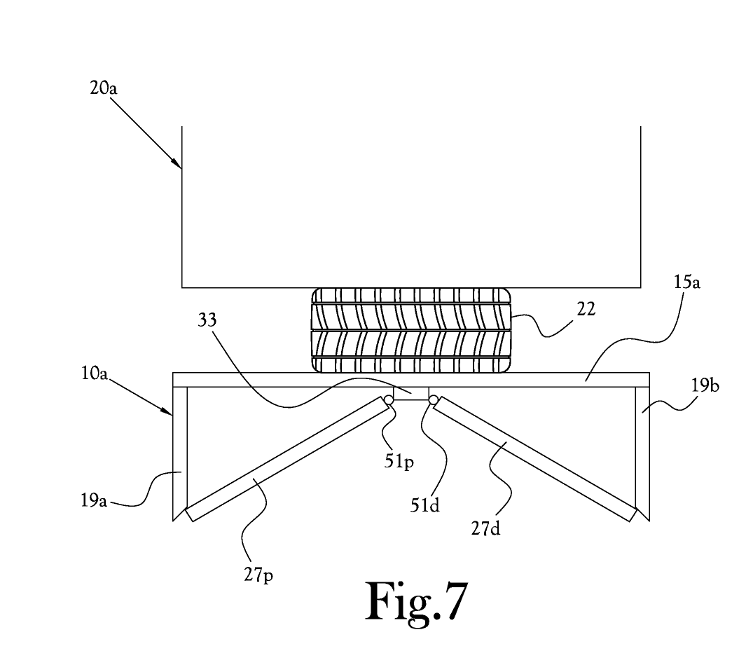

FIGS. 6 and 7 illustrate another example embodiment of the present general inventive concept, in which a two-door carrier 10a is attached to the back of a jeep 20a. The two-door carrier 10a includes a back frame 15a and side-frame members 19a and 19b, as well as a central frame member 33. The two-door carrier 10a includes holds two removed vehicle doors, the passenger-side door 27p and the driver-side door 27d. As shown in FIG. 7, the central frame member 33 includes hinge loops 51p and 51d to receive the hinges of the doors; generally, side-frame members 19a and 19b, include hooks or loops (not shown) that receive and engage the latches of the vehicle doors 27p and 27d; these components help secure the doors 27p and 27d to the two-door carrier 10a.

In some embodiments of the present general inventive concept, the carrier totally or partially covers the taillights of the vehicle, and therefore the carrier itself includes taillights that substitute for (or supplement) the taillights of the vehicle.

Some example embodiments of the present general inventive concept include a stabilizer brace on the hitch to prevent or inhibit excessive swaying.

Some example embodiments of the present general inventive concept include a ratchet strap to further secure the doors and/or the hardtop to the carrier, to keep those parts or the carrier itself from excessive swaying. Likewise, some example embodiments include safety chains.

A carrying system according to the present general inventive concept provides an apparatus and means to transport doors and hardtop for a jeep while also allowing for simultaneous utilization of the open-air, convertible-style mode of driving that is one of the principal benefits of a jeep or other convertible-style automotive vehicle. Transporting the doors and hardtop with the jeep allows the jeep, even on the road and far from home, to be converted quickly between convertible and non-convertible modes, depending on weather conditions, the preferences of the vehicle occupants, and other factors.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A carrying system for a jeep hardtop and doors, comprising:
a carrier with a frame, said frame supporting a plurality of braces and brackets to receive and support the hardtop and doors of the jeep;
a mounting member to attach said frame to a hitch on the jeep; and
an assembly to attach said frame to a rear-mounted spare tire carrier of the jeep.

2. The carrying system of claim 1 wherein said assembly to attach said frame to a rear-mounted spare tire carrier of the jeep includes bolts to fasten the frame to the rear-mounted spare tire carrier of the jeep.

3. The carrying system of claim 1 wherein said frame includes padding.

4. The carrying system of claim 1 wherein some of said braces and brackets include padding.

5. The carrying system of claim 1 wherein said frame includes a stabilizer brace.

6. The carrying system of claim 1 wherein said frame includes a ratchet strap.

7. The carrying system of claim 1 wherein said frame includes safety chains.
